(19) United States
(12) Patent Application Publication
(10) Pub. No.: US 2008/0043956 A1
(43) Pub. Date: Feb. 21, 2008

(54) Interactive menu for telephone system features

(75) Inventor: Jingsong Wu, Waltham, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Data Services Inc.

(21) Appl. No.: 11/491,209

(22) Filed: Jul. 21, 2006

(51) Int. Cl. H04M 3/42

(52) U.S. Cl. 379/201.01

(57) ABSTRACT

A method and apparatus for providing telephone system features on a telephone system is disclosed. A menu of telephone system features may be provided to a user which allows the user to select and activate the various telephone system features.

### BACKGROUND

Telephone system features are common to users of touch tone phones connected to a network such as the Public Switched Telephone Network (“PSTN”). Known system features include the type commonly known as star codes. Users may activate a large variety of features, for example, by entering in a number code after pressing the “star” key on the numerical keypad. Available star codes provide a wide range of functionality including automatically dialing the last phone number that placed a call to the user, deactivating call waiting, and activating or deactivating call forwarding for their phone line by pressing the star key on their phone's keypad, and then entering in the appropriate numerical code.

Various available telephone system features have become so numerous, however, that it may be difficult for users to remember them. For example, with respect to features involving star codes there are over fifty (“50”) known codes and associated functions. As a result, many users cannot remember, or are simply not aware of a large majority of the various telephone system features. Many of the features available to users by virtue of being connected to a telephone network are consequently not used to their full potential by users of the network.

Accordingly, there is a need for a telephone or telephone system that can more conveniently provide user access to the various available telephone system features by virtue of being connected to the network.

### BRIEF DESCRIPTION OF THE DRAWINGS

FIG. 1 illustrates an architecture of a communication system, according to an embodiment;

FIG. 2 illustrates an exemplary process for providing an interactive telephone feature menu according to an embodiment;

FIG. 3 illustrates a device displaying a telephone feature main menu, according to an embodiment; and

FIG. 4 illustrates a device displaying a telephone feature sub-menu, according to an embodiment.

### DETAILED DESCRIPTION

Various embodiments directed to a method and system for providing a telephone feature menu to a telephone user are disclosed herein. The menu generally includes a plurality of telephone features that are selectable by a user to enact any of the various star code functions. A menu according to the various embodiments may be provided in virtually any communication system where keystrokes are used that may be awkward or difficult to remember including, but not limited to, wireless telephone systems, traditional land-based phone systems, or Voice over Internet Protocol (VoIP) telephone systems.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

### Exemplary System Architecture

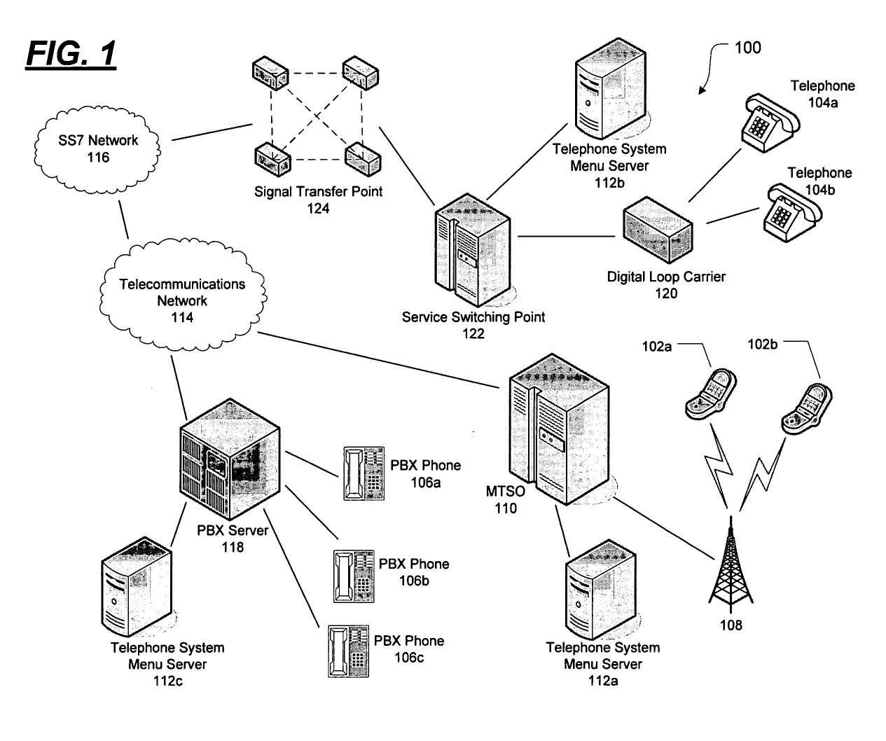

FIG. 1 illustrates a general architecture and operation of a telecommunications system 100, according to an embodiment. Wireless devices 102, conventional telephones 104, and private business exchange (PBX) phones 106 may place and receive calls over telecommunications network 114 in system 100, as is generally known. Wireless devices 102a and 102b may be wireless telephones, although other kinds of telecommunications devices may be included in various embodiments. For example, wireless devices 102 could include a variety of devices used to place and receive calls and transmit or receive other data communications such as personal computers, laptop computers, handheld computers, personal digital assistants, wireless e-mail devices, or devices that include some combination of a computer and a telephone. Conventional telephones 104a, 104b may be any land-line telephone, of which a variety of examples are known. Conventional telephones 104 may generally communicate through any Public Switched Telephone Network (PSTN). For example, conventional telephones 104 may communicate over a PSTN comprising a digital loop carrier 120, service switching point 122, and signal transfer point 124, as is generally known. PBX phones 106a, 106b, 106c may function as a part of a PBX network including PBX server 118, which is also generally known. Further, other telecommunications devices which are well known may be implemented in system 100. For example, a Voice over Internet Protocol (VoIP) device may be implemented in system 100, and may communicate with various telecommunications devices over system 100 as is generally known.

Although a small number of telecommunications devices such as wireless devices 102, conventional telephones 104, and PBX phones 106 are shown, it is to be understood that there may be a large number of telecommunications devices in communication with or through system 100 at any given time. Similarly, FIG. 1 depicts a single tower 108 and Mobile Telephone Switching Office (MTSO) 110 to allow wireless devices 102 to communicate with system 100, although it is to be understood that system 100 likely will include hundreds if not thousands of towers 108 and MTSOs 110. Further, FIG. 1 depicts a single signal transfer point 124, service switching point 122, and digital loop carrier 120 which allow conventional telephones 104 to communicate with system 100, although it is to be understood that system 100 likely will include a great number of signal transfer points 124, service switching points 122, and digital loop carriers 120. FIG. 1 additionally illustrates one PBX server 118 which allow PBX phones 106 to communicate with system 100, although in practice system 100 will likely include a great number of PBX servers 106 and associated PBX phones 106. Moreover, FIG. 1 should not be interpreted to suggest that there is necessarily any geographic limitation to system 100. In fact, system 100 may facilitate communications between different cites, states, and even countries.

Wireless device 102 generally communicates with local tower 108 within range of device 102. Tower 108 transmits communication signals from device 102 to MTSO 110. Each MTSO 110 is associated with one or more towers 108 and each generally simultaneously or nearly simultaneously handles communications for a plurality of wireless devices 102, including at least monitoring all communications, e.g., calls, tracking the location of each device 102, e.g., phone, and arranging handoffs between the various towers as may be necessary.

The structure and operation of MTSO 110 is generally well known. MTSO 110 generally includes one or more specialized computers to control a cellular telephone network. Telephone feature menu server 112a functions to provide a menu and/or a sub-menu of telephone system functions to users of wireless devices 102 generally in accordance with the methods described below. As an example, telephone feature menu server 112a may provide, at least as a subset of the menu of telephone system features, a plurality of star codes and corresponding functionality for each star code. Additionally, or in the alternative, telephone feature menu server 112a may provide virtually any other telephone system functions that are generally known, e.g., redialing, call forwarding, etc. While telephone feature menu server 112a is shown separate from MTSO 110, telephone feature menu server 112a may be included in MTSO 110, either as software and hardware added to existing MTSO 110 infrastructure, or as computer software implemented on existing MTSO 110 hardware.

MTSO 110 may be generally linked to other telecommunications devices including PBX server 118, signal transfer point 124, or another MTSO 110 by a Signaling System 7 (SS7) network 116 and a telecommunications network 114, as is well known. SS7 network 116 may provide supervising, alerting, and addressing functions. Telecommunications network 114 may be a packet-switched network, such as an internet protocol (IP) network in combination with a circuit-switched network such as the public switch telephone network (PSTN). Accordingly, it is to be understood that network 114 includes switches, links, gateways, etc. as necessary to facilitate the transmission of calls and data between devices 102, 104 and 106.

Communication signals from wireless device 102 are transmitted via network 114 when a user of a device 102 places a call or initiates other data communications. Network 114 generally routes calls from device 102 through a circuit-switched or packet-switched network to a receiver device such as conventional telephone 104, PBX phone 106, or another wireless device 102.

Communications through system 100 may also be initiated when a call is placed by conventional telephone 104a, 104b, as is generally well known. Conventional telephone 104 may be in communication with telecommunications network 114 through a PSTN linked via SS7 network 116. As an example, conventional telephone 104 may initiate a call which may be transferred through digital loop carrier 120, service switching point 122, and signal transfer point 124. Digital loop carrier may provide multiplexing/de-multiplexing functions to conventional telephones 104. Service switching point 122 and signal transfer point 124 may generally provide switching and connection functions for conventional telephones 104.

Telephone feature menu server 112b may be included as part of any of the switching applications (e.g., signal transfer point 124, service switching point 122, digital loop carrier 120, etc.) in communication with conventional telephones 104, either as software and hardware added to existing switching application infrastructure, or as computer software implemented on existing switching application hardware. Telephone feature menu server 112b provides a menu or sub-menu of telephone system features to users of conventional telephones 104 generally in accordance with the methods described below. As an example, telephone feature menu server 112b may provide star code functions and corresponding functionality for each star code function. Additionally, or in the alternative, telephone feature menu server 112b may provide any other telephone system functions that may be desirable.

Communications through system 100 may also be initiated when a call is placed by PBX phone 106a, 106b, 106c. As an example, PBX phone 106 may initiate a call which may be switched through PBX server 118, as is generally known. PBX server 118 subsequently communicates over telecommunications network 114 with any other telecommunications device such as wireless device 102, conventional telephone 104, or other PBX phone 106.

Telephone feature menu server 112c may be included as part of PBX server 118 in communication with PBX phone 106, either as software and hardware added to existing PBX server infrastructure, or as computer software implemented on existing PBX server hardware. Telephone feature menu server 112c generally provides a menu of star code functions to users of PBX phones 106 generally in accordance with the methods described below. Additionally, or in the alternative, telephone feature menu server 112c may provide any other telephone system functions that are generally known, e.g., redialing, call forwarding, etc.

It should be noted that telephone feature menu server 112 may be provided as a part of other telecommunications networks not specifically shown in FIG. 1. For example, telephone feature menu server 112 may be provided in conjunction with an optical network terminal (ONT) configuration for an enterprise-level system similar to that shown comprising PBX server 118 and PBX phones 106. Telephone feature menu server 112 could be provided in an ONT box or any server controlling routing or configuration of the various telephone system features.

Where telephone feature menu server 112 is a separate or additional piece of hardware in MTSO 106, any of the switching applications described as part of a PSTN, or PBX server 118, telephone feature menu server 112 may include any one of a number of computing devices known to those skilled in the art, including, without limitation, a computer workstation, a desktop, notebook, laptop, or handheld computer, or some other computing device known to those skilled in the art. Computing devices such as the foregoing may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system.

Computing devices in various embodiments such as telephone feature menu server 112 may each include instructions executable by one or more computing devices such as those listed above. Such instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

### Exemplary Process Flow

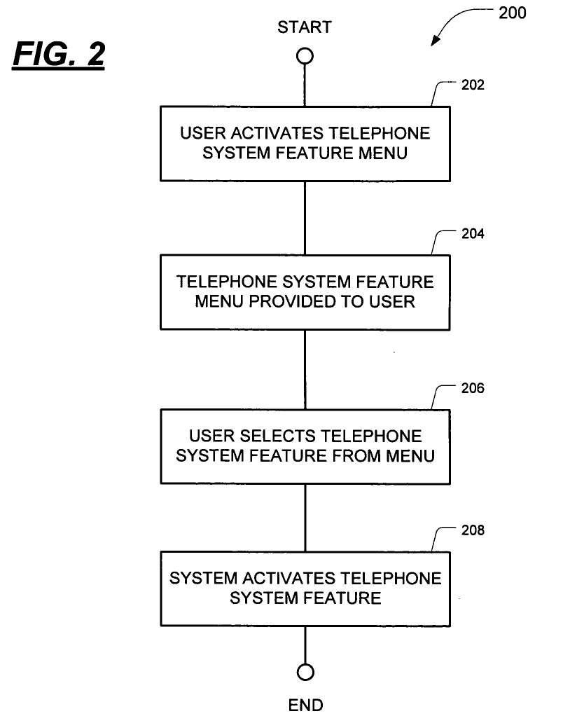

FIG. 2 illustrates a process flow 200 according to an embodiment. Process flow 200 generally comprises providing a menu of telephone system features to a user, receiving a selection of one of the telephone system features from a user, and activating the telephone system feature associated with the menu selection. Process flow 200 may be tangibly embodied in telephone feature menu server 112 as described above, or in an internal memory of a telecommunications device, as examples. For the sake of brevity, process flow 200 will be described below as being tangibly embodied in a telephone feature menu server 112.

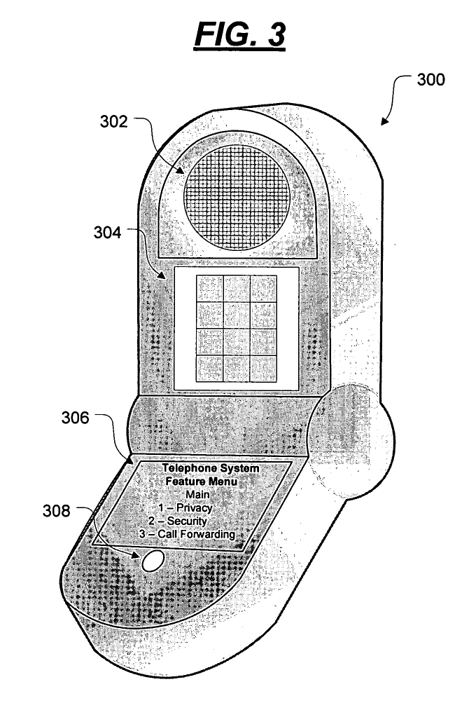

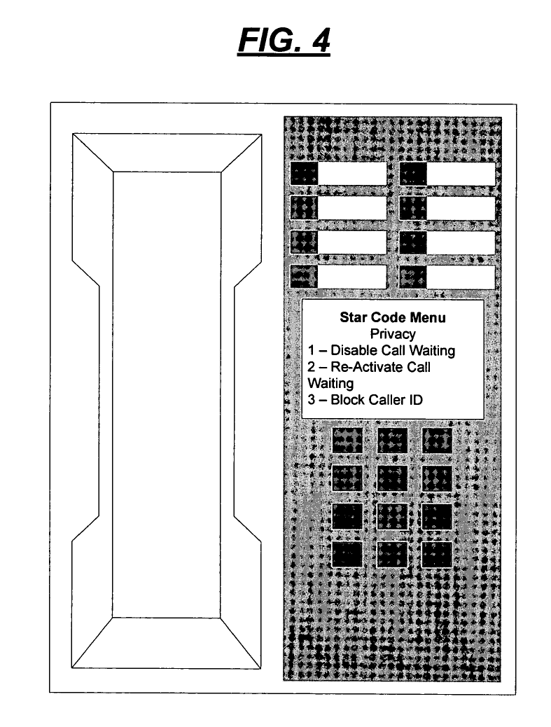

Two exemplary user interfaces are specifically described below with respect to the various embodiments of process flow 200: a keypad/screen interface, and a microphone/speaker (i.e., interactive voice response, or IVR) interface. These interfaces may be provided on any of the wireless devices 102, conventional telephones 104, or PBX phones 106, and generally facilitate the use of a telephone system features menu server by a user. The keypad/screen interface utilizes a screen and one or more buttons generally provided on a telecommunications device such as wireless device 102, conventional telephone 104, or PBX phone 106 for the user to interact with the menu of telephone system features. The microphone/speaker interface employs a microphone and speaker, such as those usually provided on telecommunications devices 102, 104, 106 for the generally known functions of talking and listening, through which the user may interact with the menu of star code functions. The user may use voice commands or other sounds given to the microphone to activate various star code functions. The telephone or telephone system, in turn, may announce through the speaker the various telephone system features and commands for the user. The keypad/screen and microphone/speaker interfaces may be combined in various forms, some of which are specifically described below in certain embodiments. For example, a telephone system is possible wherein a user could make use of either a microphone or a keypad to enter selections or commands, depending on which is most convenient to the user. Similarly, embodiments are possible wherein a user receives information via a screen or a speaker, either of which may be provided on a telephone. One embodiment is illustrated in FIG. 3 having elements of both the keypad/screen and speaker/microphone interfaces. Cell phone 300 is shown comprising speaker 302, keypad 304, screen 306, and microphone 308. An alternative embodiment employing the keypad/screen interface is shown in FIG. 4. Telephone 400 comprises keypad 404 and screen 406. It should also be noted that embodiments are possible where various parts of the keypad/screen or microphone/speaker interfaces are provided on separate pieces of equipment, such as where a user employs a telephone connected with a computer. For example, in such applications a keypad and/or microphone could be provided on a computer, while a screen and/or speaker is provided on a telephone in communication with the computer. Other embodiments are possible besides the microphone/speaker and keypad/screen interfaces which are not specifically described herein. It should be understood that these other embodiments, though not specifically described herein, are not beyond the scope of the invention. Virtually any user interface may be employed by a wireless device 102, conventional telephone 104, PBX phone 106, or other telephone system according to the various embodiments that may be convenient. Nonetheless, an embodiment comprising a speaker which audibly recites a menu, and a keypad which allows a user to select a recited menu option in response, may be easiest to implement for existing telephone systems. A speaker/keypad embodiment would be particularly convenient for PSTN or “land-line” telephone embodiments since the system could utilize the speaker and keypad hardware which is typically already provided on conventional telephones 104. Additionally, the speaker embodiments would generally not require any conversion from PSTN data to text, as may be required for screen embodiments.

Turning back to FIG. 2, process 200 is described according to an embodiment. In step 202 of process 200, a user initiates a menu of telephone system features. This may be accomplished in any manner known in the art. For example, a user may press a button provided on his or her wireless device 102, conventional telephone 104, PBX phone 106, or other telephone system to activate the menu of telephone system features. A telephone may be equipped with a dedicated button or keypad for this function. Alternatively, a button already provided in the numeric keypad commonly used for dialing telephone numbers may be utilized for activating the menu. As an example, a user may activate the menu by simply pressing the “star” key of the numeric keypad.

Alternatively, or in addition to the keypad, a user may activate the menu through a voice command system employing a microphone/speaker interface. The user may simply announce a voice command into a microphone disposed on the phone to initiate the menu. Any activation signal from the user may be transmitted to telephone feature menu server 112 through system 100.

Regardless of how the user interface is provided, the telephone system may respond to the user's activating the telephone feature menu by providing the menu to the user, as described in further detail below in step 204. The telephone system may generally provide such a response to the user's command for the menu either through telephone feature menu server 112 as described above in FIG. 1, or an internal memory of the telecommunications device itself, as examples.

The menu of telephone system features may generally include any telephone system features known in the art, e.g., re-dialing the last dialed number, returning the last call received, enabling/disabling call waiting, activating/de-activating call forwarding, etc. Other telephone system functions not expressly mentioned herein, including other star code functions, are well known, and are contemplated by the various embodiments, although not specifically mentioned. Additionally, the telephone system feature menu may be provided as a main menu and a series of sub-menus of various telephone system features, arranged in any manner convenient. There currently exist a great number of known telephone system features, including at least fifty (“50”) star code functions, and the various telephone system features may be arranged and provided through a main menu and hierarchy of sub-menus to make selecting a desired telephone system feature more convenient. An example of a main menu is shown displayed on screen 306 of cell phone 300 in FIG. 3. A user could select a certain category of telephone system features (e.g., privacy features) from a main menu. The user could subsequently view a sub-menu relating to that category (e.g., privacy features such as block outgoing caller identification, deactivate call waiting, call forwarding, etc.), such that the user could quickly and easily find a desired telephone system feature. An example of a sub-menu for privacy features is shown displayed on screen 406 of telephone 400 in FIG. 4. A hierarchy of menus and sub-menus would reduce any inconvenience caused by the large number of available telephone system features, and enable efficient selection of the desired telephone system feature.

In step 204 of process 200, a menu of telephone system features is provided to the user. This may be done in any manner known in the art, through any user interface that may be convenient. As an example, a telephone may be equipped with a screen which displays various telephone system features, such as star code functions, to the user. The user may learn which telephone system features are available by viewing a menu or sub-menu on the screen. The screen may additionally provide information to the user that indicates how to enact each telephone system feature. As an example, the menu may display numerical references or codes indicating which numbers to press on the numerical keypad to activate a given star code function. Additionally, the telephone system feature menu may be displayed as a main menu which describes a series of categories for various telephone feature sub-menus which are arranged in any manner convenient (e.g., alphabetically, by category, etc.). Selection of a particular category by a user would preferably take the user to a sub-menu of telephone system features in the relevant category.

As another example, the various telephone system features may be audibly recited to the user via a speaker on the telephone. The audible menu may provide reference information (e.g., titles, numerical codes, etc.) indicating which telephone system features are available and how to activate each of them.

Alternatively, the screen and speaker embodiments could be combined. A telephone could be equipped with a screen to display a menu of telephone system features, as well as a speaker through which the menu could be announced for the user, either alone or in combination with the screen of the telephone. The user would thus be able to choose a preferred method of receiving the information provided on the telephone system feature menu.

In step 206 of process 200, the user selects a telephone system feature from the telephone system feature menu. This may be accomplished through any method known in the art. Embodiments utilizing a keypad/screen interface may allow a user to select a telephone system feature by pressing the relevant keypads to indicate one or more telephone system feature listed on the telephone system feature menu as described above in step 204. As an example, a user may simply enter a reference number or code which is displayed/recited adjacent each telephone system feature displayed/recited in the menu. Alternatively, or in addition, any of the variety of telephone system features may be selectable on the menu provided on the screen, whereby a user may select a telephone system feature without being required to enter in the reference code itself. As a further example, a user may simply enter a star code after viewing or listening to the telephone system feature menu as described above in step 204.

Alternatively or in combination with the keypad/screen embodiments, the user may be provided with a microphone, whereby the user may announce a voice command (as indicated to the user above in step 204) into the microphone to activate the relevant telephone system feature. As an example, the user may be allowed to announce a reference code associated with a telephone system feature, such as the numerical code of a star code function, into a speaker to select that particular telephone system feature. Alternatively, a user may announce a title associated with the desired telephone system feature into the speaker to select the desired telephone system feature.

In step 208 of process 200, the telephone or telephone system may activate the telephone system feature selected by the user. This may be performed in any manner known in the art. As an example, telephone feature menu server 112 may initiate a telephone system feature upon selection by the user from any telecommunications device such as wireless device 102, conventional telephone 104, or PBX phone 106. Telephone feature menu server 112 would ideally connect the user with a dial tone after activating the selected star code function, such that the selected star code function would be activated for a subsequent phone call by the user. From the viewpoint of the user, such a system would be relatively similar in use and appearance to current telephone systems employing various star code functions, and would therefore be extremely user-friendly.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

In general, the foregoing description is intended to be illustrative and not restrictive. Many embodiments and applications other than the examples provided will be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A method comprising:
providing a menu to a user of a telephone, said menu comprising a plurality of telephone system features permitting interaction between said telephone and a corresponding network to which said telephone is connected;
receiving a menu selection from the user, said menu selection being associated with at least one of said plurality of telephone system features; and
activating said at least one of said plurality of said system features.

2. The method of claim 1, further comprising using star codes as an available subset of said plurality of telephone system features.

3. The method of claim 1, wherein providing said menu to the user comprises providing an audible menu.

4. The method of claim 3, wherein providing said audible menu comprises providing a plurality of audible titles, each of said plurality of titles being associated with at least one of said plurality of telephone system features.

5. The method of claim 4, wherein providing said plurality of telephone system features comprises playing said audible titles through a speaker associated with the telephone.

6. The method of claim 3, wherein receiving said menu selection from the user comprises receiving an audible response from the user.

7. The method of claim 1, wherein said providing of said menu to the user comprises displaying said menu to the user.

8. The method of claim 7, wherein said displaying of said menu to the user comprises displaying a plurality of titles, each of said plurality of titles being associated with at least one of said plurality of telephone system features.

9. The method of claim 7, wherein said receiving of said menu selection from the user comprises accepting a keypad command from the user.

10. The method of claim 1, further comprising the step of providing said menu in response to a request from the user.

11. The method of claim 10, wherein said request from the user comprises a voice command.

12. The method of claim 10, wherein said request from the user comprises a keypad command.

13. A telephone system comprising:
a computer-readable medium storing a plurality of telephone system features;
a menu comprising at least a subset of said plurality of telephone system features; and
a telephone communicating said menu to a user, one of said subset of telephone system features being selectable by said user, wherein said computer-readable medium initiates said selectable telephone system feature.

14. The telephone system of claim 13, wherein said telephone comprises a display presenting said menu.

15. The telephone system of claim 13, wherein said telephone comprises a speaker audibly reciting said menu.

16. The telephone system of claim 13, wherein said computer-readable medium comprises a memory of said telephone.

17. The telephone system of claim 13, wherein said medium comprises an application server.

18. The telephone system of claim 17, wherein said application server comprises a switching application.

19. The telephone system of claim 18, wherein said switching application comprises at least one of a signal transfer point, a service switching point, and a digital loop carrier.

20. A system for providing telephone system features to a plurality of telephones comprising:
a menu server in communication with a telephone network, said telephone network providing a plurality of telephone system features to at least one telephone;
a menu of telephone system features supported by said menu server, said menu comprising a plurality of references, each of said references associated with one of said plurality of telephone system features; and
a telephone associated with said telephone network, said telephone in communication with said menu server and operable to select at least one of said references, said menu server activating said associated telephone system feature.

21. The system of claim 20, further comprising a plurality of star codes as an available subset of said plurality of telephone system features.

22. The system of claim 20, wherein the telephone comprises at least one of a speaker operable to audibly present said menu and a display operable to visibly present said menu.

23. The system of claim 20, wherein each of said references comprises at least one of a title of one of said plurality of telephone system features and a numerical code associated with one of said plurality of telephone system features.
